(19) United States
(12) Patent Application Publication
(10) Pub. No.: US 2026/0110841 A1
(43) Pub. Date: Apr. 23, 2026

(54) OPTICAL WAVEGUIDE ELEMENT

(71) Applicant: SUMITOMO ELECTRIC INDUSTRIES, LTD., Osaka (JP)

(72) Inventors: Akira FUJISAWA, Osaka-shi (JP); Keiji TANAKA, Osaka-shi (JP); Yoshiyuki SUGIMOTO, Osaka-shi (JP)

(73) Assignee: SUMITOMO ELECTRIC INDUSTRIES, LTD., Osaka (JP)

(21) Appl. No.: 19/365,292

(22) Filed: Oct. 22, 2025

(30) Foreign Application Priority Data
Oct. 23, 2024 (JP) 2024-186784

(51) Int. Cl. G02B 6/14

(52) U.S. Cl. CPC G02B 6/14

(57) ABSTRACT

An optical waveguide element according to one embodiment incudes a substrate; a strip waveguide portion formed in a first layer located above the substrate; a slot waveguide portion formed in a second layer located above the substrate and different from the first layer; and a mode conversion portion connected between the strip waveguide portion and the slot waveguide portion. The mode conversion portion includes a first optical confinement portion formed in the first layer and connected to the strip waveguide portion, and a pair of second optical confinement portions formed in the second layer and connected to the slot waveguide portion. A width of the first optical confinement portion decreases as the first optical confinement portion approaches the slot waveguide portion from the strip waveguide portion. The first optical confinement portion is included inside the pair of second optical confinement portions in a plan view of the substrate.

### CROSS REFERENCE TO RELATED APPLICATIONS

This application claims priority based on Japanese Patent Application No. 2024-186784 filed on October 23, 2024, and the entire contents of the Japanese patent application are incorporated herein by reference.

### TECHNICAL FIELD

The present disclosure relates to an optical waveguide element.

### BACKGROUND

United States Patent Application, Publication No. 2014/0219602 describes a waveguide coupler configured to optically couple a strip waveguide to a first slot photonic crystal waveguide. The waveguide coupler is disposed between the first slot photonic crystal waveguide and the strip waveguide. The waveguide coupler includes a tapered region including a first slot photonic crystal waveguide and a second slot photonic crystal waveguide aligned with the strip waveguide.

The article by Q. Deng et al., “Strip-Slot Waveguide Mode Converter Based on Symmetric Multimode Interference”, published in Optics Lett. Vol. 39, Issue 19, pp.5665-5668 (2014), describes a structure in which a tapered section is provided between a slot waveguide and a strip waveguide. The strip waveguide includes a strip portion with a high refractive index as a core, and as the width of the strip portion increases, the optical confinement becomes stronger. In the slot waveguide, a low refractive index portion sandwiched between two strip portions with a high refractive index serves as a core. As the distance between two strip portions increases, the optical confinement of the slot waveguide becomes weaker. In the tapered section, the width of the strip waveguide is gradually reduced to weaken the optical confinement, and the distance between the slot waveguides is gradually reduced to strengthen the optical confinement in the slot waveguides, thereby converting light between the two waveguides.

### SUMMARY

An optical waveguide element according to the present disclosure includes a substrate; a strip waveguide portion formed in a first layer located above the substrate; a slot waveguide portion formed in a second layer located above the substrate and different from the first layer; and a mode conversion portion connected between the strip waveguide portion and the slot waveguide portion. The mode conversion portion includes a first optical confinement portion formed in the first layer and connected to the strip waveguide portion, and a pair of second optical confinement portions formed in the second layer and connected to the slot waveguide portion. A width of the first optical confinement portion decreases as the first optical confinement portion approaches the slot waveguide portion from the strip waveguide portion. The first optical confinement portion is included inside the pair of second optical confinement portions in a plan view of the substrate.

### BRIEF DESCRIPTION OF THE DRAWINGS

FIG. 1 is a plan view showing an optical waveguide element according to an embodiment.

FIG. 2 is a cross-sectional view taken along line B-B of FIG. 1.

FIG. 3 is a schematic view showing beam shapes in a cross-section taken along line A-A of FIG. 1, a cross-section taken along line B-B of FIG. 1, a cross-section taken along line C-C of FIG. 1, and a cross-section taken along line D-D of FIG. 1.

FIG. 4 is a graph showing an example of the relationship between the length and the conversion efficiency of a mode conversion portion of the optical waveguide element.

### DETAILED DESCRIPTION

By the way, the optical waveguide element may include a plurality of different materials. For example, when a plurality of layers can be stacked and formed on a semiconductor substrate by a semiconductor process, manufacturing can be performed efficiently by forming a plurality of different materials in different layers. Therefore, in the optical waveguide element, it is required to be able to perform mode conversion of light propagating between a strip waveguide portion and a slot waveguide portion formed in different layers.

An object of the present disclosure is to provide an optical waveguide element capable of efficiently performing mode conversion of light propagating between a strip waveguide portion and a slot waveguide portion formed in different layers on a semiconductor substrate.

According to the present disclosure, it is possible to efficiently perform mode conversion of light propagating between the strip waveguide portion and the slot waveguide portion formed in different layers on the semiconductor substrate.

First, the contents of an embodiment of the present disclosure will be listed and described. (1) An optical waveguide element according to one embodiment includes a substrate; a strip waveguide portion formed in a first layer located above the substrate; a slot waveguide portion formed in a second layer located above the substrate and different from the first layer; and a mode conversion portion connected between the strip waveguide portion and the slot waveguide portion. The mode conversion portion includes a first optical confinement portion formed in the first layer and connected to the strip waveguide portion, and a pair of second optical confinement portions formed in the second layer and connected to the slot waveguide portion. A width of the first optical confinement portion decreases as the first optical confinement portion approaches the slot waveguide portion from the strip waveguide portion. The first optical confinement portion is included inside the pair of second optical confinement portions in a plan view of the substrate.

In the optical waveguide element, the strip waveguide portion and the slot waveguide portion are formed above the substrate, and the mode conversion portion is located between the strip waveguide portion and the slot waveguide portion. The mode conversion portion includes the first optical confinement portion and the second optical confinement portions. The first optical confinement portion is connected to the strip waveguide portion, and the second optical confinement portions are connected to the slot waveguide portion. The width of the first optical confinement portion decreases as the first optical confinement portion approaches the slot waveguide portion from the strip waveguide portion, and the first optical confinement portion is included inside the second optical confinement portions in a plan view of the substrate. As a result, the width of the first optical confinement portion decreases as the first optical confinement portion approaches the slot waveguide portion, and a spacing between the second optical confinement portions that sandwich the first optical confinement portion therebetween in a plan view of the substrate decreases as the second optical confinement portions approach the slot waveguide portion. Therefore, the conversion of light in the mode conversion portion located between the strip waveguide portion and the slot waveguide portion can be smoothly performed.

(2) In (1) above, the strip waveguide portion, the mode conversion portion, and the slot waveguide portion may be arranged in order along a first direction, and one of the pair of second optical confinement portions, the first optical confinement portion, and the other of the pair of second optical confinement portions may be arranged in order along a second direction intersecting the first direction. The pair of second optical confinement portions may be formed to be line-symmetric with each other with respect to a reference line passing through a center of the first optical confinement portion in the second direction and extending along the first direction. In this case, two second optical confinement portions are disposed at positions where the two second optical confinement portions are symmetric with each other with respect to the reference line, and therefore, the rotation of the mode, that is, polarization can be suppressed.

(3) In (2) above, a difference between a distance between the pair of second optical confinement portions arranged along the second direction and the width of the first optical confinement portion may decrease monotonically as the pair of second optical confinement portions and the first optical confinement portion approach the slot waveguide portion from the strip waveguide portion. In this case, the conversion of light in the mode conversion portion can be more smoothly performed.

(4) In any one of (1) to (3) above, a width of each of the second optical confinement portions may decrease monotonically as the second optical confinement portion extends from the slot waveguide portion toward the strip waveguide portion. In this case, since the width of the second optical confinement portion in the strip waveguide portion is smaller than the width of the second optical confinement portion in the slot waveguide portion, the reflection of light from the strip waveguide portion toward the slot waveguide portion can be suppressed.

(5) In any one of (1) to (4) above, in a cross-section orthogonal to a first direction in which the strip waveguide portion, the mode conversion portion, and the slot waveguide portion are arranged, the first layer may be formed above and spaced apart from the second layer.

(6) In any one of (1) to (5) above, the slot waveguide portion may have the same optical propagation mode as an optical propagation mode of the strip waveguide portion.

(7) In any one of (1) to (6) above, the optical waveguide element may further include a cladding formed on the substrate, and the first layer and the second layer may be provided in the cladding.

Hereinafter, a specific example of an optical waveguide element according to an embodiment will be described with reference to the drawings. The present disclosure is not limited to this example, but is defined by the claims, and is intended to include all modifications within the concept and scope of the claims and equivalents thereof. In the description of the drawings, the same or corresponding elements are denoted by the same reference signs, and duplicate descriptions will be omitted as appropriate. The drawings may be partially depicted in a simplified or exaggerated manner for ease of understanding, and dimensional ratios and the like are not limited to those shown in the drawings.

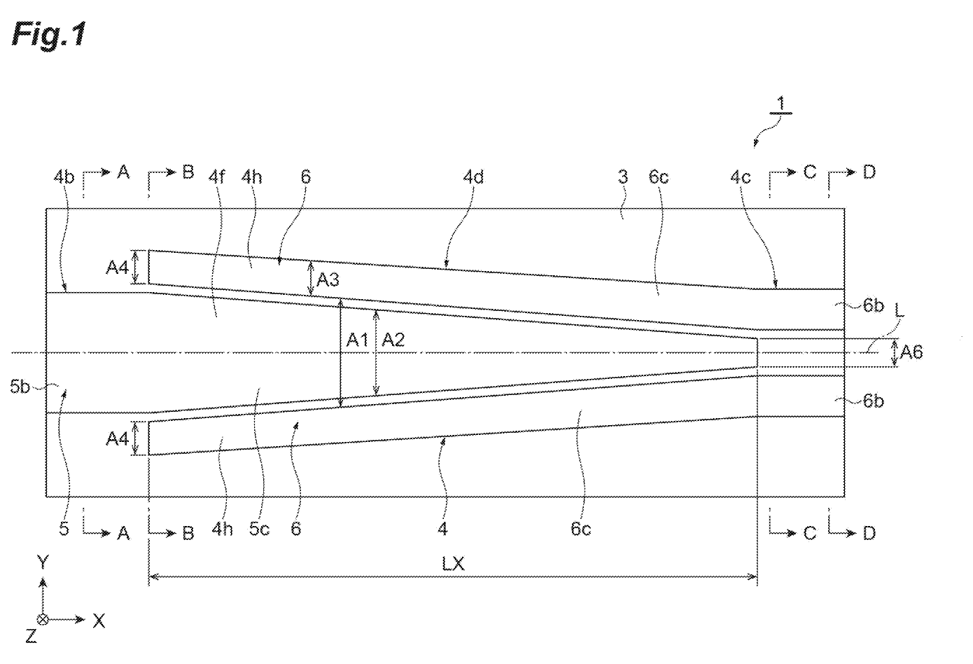

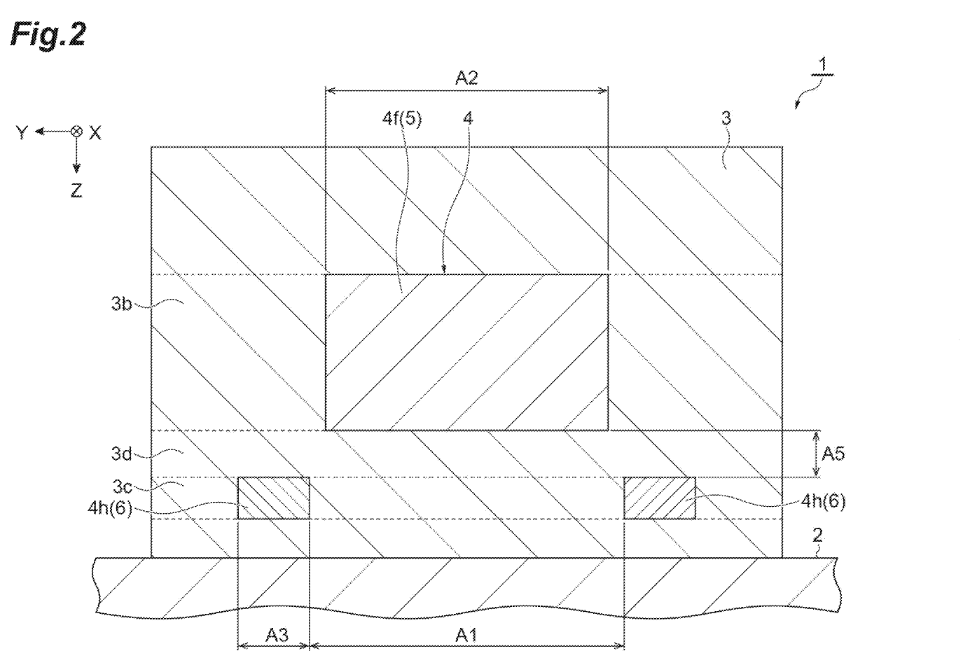

FIG. 1 is a view showing an optical waveguide element 1 according to the present embodiment. FIG. 2 is a cross-sectional view taken along line B-B of FIG. 1. As shown in FIGS. 1 and 2, the optical waveguide element 1 includes a substrate 2; a cladding 3 formed on the substrate 2; and an optical waveguide portion 4 embedded in the cladding 3. Hereinafter, the direction from the substrate 2 toward the cladding 3 may be referred to as top, upper side, or upward, and the direction from the cladding 3 toward the substrate 2 may be referred to as bottom, lower side, or downward. However, these directions are defined for the convenience of description, and do not limit the disposition positions or directions of the components. The cladding 3 may be called cladding layer.

The optical waveguide portion 4 is also referred to as a core. The substrate 2 is, for example, a semiconductor substrate. The semiconductor substrate is made of, for example, silicon (Si). In FIG. 1, for clarity of illustration, the optical waveguide portion 4 is shown by a solid line. For example, the cladding 3 has a thickness in a Z-axis direction intersecting both an X-axis direction and a Y-axis direction. Hereinafter, the X-axis direction, the Y-axis direction, and the Z-axis direction are also referred to as a first direction, a second direction, and a third direction, respectively. As one example, the cladding 3 has a rectangular parallelepiped shape extending in the X-axis direction, the Y-axis direction, and the Z-axis direction. X-axis direction and Y-axis direction correspond to the first direction and the second direction respectively. The cladding 3 includes, for example, a first layer 3b; a second layer 3c located between the first layer 3b and the substrate 2; and an intermediate layer 3d located between the first layer 3b and the second layer 3c. The cladding 3 further includes the intermediate layer 3d located between the first layer 3b and the second layer 3c. The first layer 3b and the second layer 3c are provided in the cladding 3. Each of the first layer 3b and the second layer 3c extends in the X-axis direction and the Y-axis direction, and has a thickness in the Z-axis direction. For example, the first layer 3b is provided at the center of the cladding 3 in the Z-axis direction, and the second layer 3c is provided below the first layer 3b. For example, the cladding 3 is made of, for example, silicon dioxide (SiO₂). The optical waveguide portion 4 is surrounded by the cladding 3.

The optical waveguide portion 4 functions as a core of the optical waveguide element 1. Due to a difference between the refractive index of the core and the refractive index of the cladding, for example, light is confined within the core, and the light propagates in an extending direction of the core. The optical waveguide portion 4 includes a strip waveguide portion 4b formed in the first layer 3b located above the substrate 2; a slot waveguide portion 4c formed in the second layer 3c located above the substrate 2 and different from the first layer 3b; and a mode conversion portion 4d located between the strip waveguide portion 4b and the slot waveguide portion 4c. In a plan view of the substrate 2 viewed along the Z-axis direction, the strip waveguide portion 4b, the mode conversion portion 4d, and the slot waveguide portion 4c are arranged in order along the X-axis direction.

The slot waveguide portion 4c is configured to have the same mode as a mode when light propagating through the slot waveguide portion 4c propagates through the strip waveguide portion 4b. For example, in the optical waveguide element 1, light is transmitted from the strip waveguide portion 4b to the slot waveguide portion 4c via the mode conversion portion 4d. However, conversely, light may be transmitted from the slot waveguide portion 4c to the strip waveguide portion 4b via the mode conversion portion 4d. For example, the strip waveguide portion 4b transmits light in a transverse electric wave (TE) mode, and the slot waveguide portion 4c transmits light in the TE mode. The strip waveguide portion 4b may transmit light in a transverse magnetic wave (TM) mode, and the slot waveguide portion 4c may transmit light in the TM mode. With the direction horizontal with respect to an upper surface of substrate 2 (the X-axis direction and the Y-axis direction) defined as a horizontal direction and with the direction perpendicular to the upper surface of substrate 2 (Z-axis direction) defined as a vertical direction, in the TE mode, the electric field of propagating light oscillates in the horizontal direction, and in the TM mode, the electric field of propagating light oscillates in the vertical direction. The polarization direction of light is the horizontal direction in the TE mode, and is the vertical direction in the TM mode.

The optical waveguide portion 4 includes a SiN waveguide 5 and a Si waveguide 6 owing to the difference in the materials constituting each. For example, light in a TE0 mode input from the SiN waveguide 5 transitions to the TE0 mode on the Si waveguide 6 side. The SiN waveguide 5 is formed to propagate light in the TE mode, and the Si waveguide 6 is formed to propagate light in the TE mode. The SiN waveguide 5 may be formed to propagate light in the TM mode, and the Si waveguide 6 may be formed to propagate light in the TM mode. The SiN waveguide 5 is made of silicon nitride (Si₃N₄), and the Si waveguide 6 is made of silicon (Si). For example, in a plan view of the substrate 2 (when viewed along the Z-axis direction), the SiN waveguide 5 includes a first portion 5b having a rectangular shape and a second portion 5c having a trapezoidal shape. The optical waveguide portion 4 includes a pair of Si waveguides 6. Each of the pair of Si waveguides 6 includes a third portion 6b having a rectangular shape and a fourth portion 6c having a trapezoidal shape. The pair of Si waveguides 6 are arranged along the Y-axis direction.

The strip waveguide portion 4b includes the first portion 5b of the SiN waveguide 5, and the slot waveguide portion 4c includes the third portions 6b of the Si waveguides 6. The mode conversion portion 4d includes the second portion 5c of the SiN waveguide 5 and the fourth portions 6c of the Si waveguides 6. The mode conversion portion 4d is a tapered region in which a width (length in the Y-axis direction) of the optical waveguide portion 4 decreases as the optical waveguide portion 4 extends in the X-axis direction. A length LX of the mode conversion portion 4d in the X-axis direction is, for example, 20 μm or more and 500 μm or less. The length LX of the mode conversion portion 4d in the X-axis direction may be, for example, 50 μm or more and 400 μm or less. The length LX of the mode conversion portion 4d in the X-axis direction may be, for example, 200 μm or more and 300 μm or less.

The mode conversion portion 4d includes a first optical confinement portion 4f connected to the strip waveguide portion 4b and a pair of second optical confinement portions 4h connected to the slot waveguide portion 4c. The first optical confinement portion 4f is formed in the first layer 3b, and the second optical confinement portions 4h are formed in the second layer 3c. The first optical confinement portion 4f is formed integrally (as a continuous body) with the strip waveguide portion 4b. The second optical confinement portion 4h is formed as a continuous body with the third portion 6b of the Si waveguide 6. A width of the first optical confinement portion 4f decreases monotonically as the first optical confinement portion 4f approaches the slot waveguide portion 4c from the strip waveguide portion 4b. The first optical confinement portion 4f is included inside the pair of second optical confinement portions 4h in a plan view of the substrate 2. For example, the mode conversion portion 4d includes the pair of second optical confinement portions 4h, and one first optical confinement portion 4f is formed between the pair of second optical confinement portions 4h. For example, the positions (heights) of the pair of second optical confinement portions 4h in the Z-axis direction are the same. In a plan view of the substrate 2, one second optical confinement portion 4h, the first optical confinement portion 4f, and the other second optical confinement portion 4h are arranged in order along the Y-axis direction.

For example, the first optical confinement portion 4f is the second portion 5c of the SiN waveguide 5, and the second optical confinement portion 4h is the fourth portion 6c of the Si waveguide 6. In a plan view of the substrate 2, the SiN waveguide 5 is disposed between the pair of Si waveguides 6. In a plan view of the substrate 2, the SiN waveguide 5 and two Si waveguides 6 are formed at positions that do not overlap each other. In a plan view of the substrate 2, the pair of Si waveguides 6 are formed at positions where the pair of Si waveguides 6 are line-symmetric with each other with respect to a reference line L passing through the center of the cladding 3 in the Y-axis direction and extending along the X-axis direction. That is, in a plan view of the substrate 2, the reference line L can be imagined as an axis of symmetry, with respect to which the shapes of the pair of Si waveguides 6 are line-symmetric with each other. In this case, the reference line L may not pass through the center of the cladding 3 in the Y-axis direction. In a plan view of the substrate 2, the SiN waveguide 5 has a shape that is line-symmetric with respect to the reference line L.

The pair of second optical confinement portions 4h are disposed at positions where the pair of second optical confinement portions 4h are line-symmetric with respect to the reference line L. For example, a center line passing through the center of the first optical confinement portion 4f in the Y-axis direction and extending along the X-axis direction (hereinafter, referred to as a first center line) and a center line passing through the center of the pair of second optical confinement portions 4h in the Y-axis direction and extending along the X-axis direction (hereinafter, referred to as a second center line) are coincident with each other. The second center line corresponds to the axis of symmetry related to the line symmetry described above. The first center line and the second center line may be coincident with the reference line L. A difference between a distance A1 between the pair of second optical confinement portions 4h arranged along the Y-axis direction and a width A2 of the first optical confinement portion 4f is constant along the X-axis direction. In addition, the difference between the distance A1 and the width A2 may decrease monotonically as the pair of second optical confinement portions 4h and the first optical confinement portion 4f approach the slot waveguide portion 4c from the strip waveguide portion 4b. A width A3 (length in the Y-axis direction) of each of the pair of second optical confinement portions 4h decreases monotonically as the second optical confinement portion 4h extends from the slot waveguide portion 4c toward the strip waveguide portion 4b. The cladding 3 is interposed between the first optical confinement portion 4f and the pair of second optical confinement portion 4h in the Z-axis direction. For example, along the Z-axis direction, the intermediate layer 3d is stacked on the second layer 3c including the pair of second optical confinement portions 4h (Si waveguides 6), and the first layer 3b including the first optical confinement portion 4f (SiN waveguide 5) is stacked on the intermediate layer 3d. That is, the SiN waveguide 5 is formed in a layer higher than the layer of the Si waveguides 6.

For example, the first optical confinement portion 4f (SiN waveguide 5) is disposed at a position above and spaced apart from the second optical confinement portions 4h (Si waveguides 6) in a cross-section orthogonal to the X-axis direction. However, the first optical confinement portion 4f may be disposed at a position below and spaced apart from the second optical confinement portions 4h in a cross-section orthogonal to the X-axis direction. That is, the positional relationship between the first optical confinement portion 4f and the second optical confinement portions 4h in a cross-section orthogonal to the X-axis direction may be reversed. Hereinafter, in a cross-section orthogonal to the X-axis direction, the direction in which the SiN waveguide 5 is viewed from the pair of Si waveguides 6 may be referred to as top, and the direction in which the pair of Si waveguides 6 are viewed from the SiN waveguide 5 may be referred to as bottom. In this case, the substrate 2 is located below the Si waveguides 6, and the pair of Si waveguides 6, the SiN waveguide 5, and the cladding 3 are formed on the substrate 2. However, these directions are defined for the convenience of describing relative positions and directions, and do not limit absolute disposition positions and directions that are independent of the orientation of the substrate 2.

In the mode conversion portion 4d, the width of the SiN waveguide 5 (the width A2 of the first optical confinement portion 4f) in a plan view of the substrate 2 decreases monotonically as the SiN waveguide 5 extends toward the slot waveguide portion 4c, and therefore, as light propagating through the SiN waveguide 5 travels toward the slot waveguide portion 4c, the optical confinement in the first optical confinement portion 4f becomes weaker, and the components spreading out of the interface between the core and the cladding increase. Further, in the mode conversion portion 4d, the distance A1 between the pair of Si waveguides 6 in the Y-axis direction in a plan view of the substrate 2 decreases monotonically together with the width A2 of the first optical confinement portion 4f, and therefore, as light travels toward the slot waveguide portion 4c, the optical confinement in the second optical confinement portions 4h that is close to the first optical confinement portion 4f gradually becomes stronger, and finally, all the light propagating through the SiN waveguide 5 transitions to the second optical confinement portions 4h. Accordingly, the light is smoothly converted from the SiN waveguide 5 to the Si waveguides 6.

As described above, the width A3 of each of the second optical confinement portions 4h decreases monotonically as the second optical confinement portion 4h extends from the slot waveguide portion 4c toward the strip waveguide portion 4b. A width A4 of the second optical confinement portion 4h at a location farthest from the slot waveguide portion 4c is, for example, greater than 0 μm and equal to or less than 0.2 μm. The lower limit of the width A4 is a minimum value to which manufacturing can be performed by a semiconductor process used in the manufacture of the optical waveguide element 1, and may be, for example, 0.05 μm. At a boundary portion between the strip waveguide portion 4b and the mode conversion portion 4d, the smaller the width A4 is, the more the reflection of light, which has propagated through the first portion 5b, toward a negative side in the X-axis direction can be reduced.

In order to cause the transition of light from the first optical confinement portion 4f to the second optical confinement portion 4h as described above, the difference between the distance A1 and the width A2 at an end portion of the second optical confinement portion 4h on the negative side in the X-axis direction (that is, at the boundary portion between the strip waveguide portion 4b and the mode conversion portion 4d in the X-axis direction) needs to be a value which allows optical coupling such that the components spreading out of the first optical confinement portion 4f enter the second optical confinement portion 4h. For example, the difference between the distance A1 and the width A2 is smaller than the width A2, and is smaller than the width A3. The difference between the distance A1 and the width A2 is, for example, greater than 0 μm and equal to or less than 0.2 μm. The distance A1 is greater than the width A2, and in a plan view of the substrate 2, the first optical confinement portion 4f and the second optical confinement portions 4h do not overlap each other. The lower limit of the difference between the distance A1 and the width A2 is a minimum value to which manufacturing can be performed by a semiconductor process used in the manufacture of the optical waveguide element 1, and may be, for example, 0.05 μm. The width A3 increases monotonically as the second optical confinement portion 4h extends from the strip waveguide portion 4b toward the slot waveguide portion 4c, and the width of the second optical confinement portion 4h (for example, the maximum value of the width A3) in the slot waveguide portion 4c is, for example, 0.2 μm or more and 0.3 μm or less (as one example, 0.24 μm). The width A3 may increase uniformly (at a constant rate) as the second optical confinement portion 4h extends from the strip waveguide portion 4b toward the slot waveguide portion 4c. This constant rate is determined, for example, by the amount of change in the width A3 relative to the length LX of the strip waveguide portion 4b in the X-axis direction.

A spacing A5 between the first optical confinement portion 4f and the second optical confinement portions 4h in the Z-axis direction is, for example, greater than 0 μm and equal to or less than 0.2 μm (as one example, 0.1 μm). In the portion having the spacing A5, SiO₂ is formed as the intermediate layer 3d of the cladding 3. The lower limit of the spacing A5 is a minimum value to which manufacturing can be performed by a semiconductor process used in the manufacture of the optical waveguide element 1, and may be, for example, 0.05 μm. The spacing A5 may be 1.0 μm or less. By setting the spacing A5 to an appropriate value, the transition of light from the first optical confinement portion 4f to the second optical confinement portions 4h in the mode conversion portion 4d can be appropriately performed. The shape of the first optical confinement portion 4f in a cross-section orthogonal to the X-axis direction is, for example, a rectangular shape.

For example, when taken along a plane orthogonal to the X-axis direction, a length (width) of the cross-section of the first optical confinement portion 4f in the Y-axis direction is greater than a length (thickness) of the cross-section of the first optical confinement portion 4f in the Z-axis direction. The shape of the second optical confinement portion 4h in a cross-section orthogonal to the X-axis direction is, for example, a rectangular shape. For example, when taken along a plane orthogonal to the X-axis direction, a length (width) of the second optical confinement portion 4h in the Y-axis direction is greater than a length (thickness) of the second optical confinement portion 4h in the Z-axis direction.

For example, an area of the cross-section of the first optical confinement portion 4f orthogonal to the X-axis direction is greater than an area of the cross-section of each of the pair of second optical confinement portions 4h orthogonal to the X-axis direction. An example in which the shape of the first optical confinement portion 4f in a cross-section orthogonal to the X-axis direction and the shape of the second optical confinement portions 4h in a cross-section orthogonal to the X-axis direction are a rectangular shape has been described above. However, the shape of the first optical confinement portion 4f in a cross-section orthogonal to the X-axis direction and the shape of the second optical confinement portions 4h in a cross-section orthogonal to the X-axis direction may be a trapezoidal shape. For example, the trapezoidal shape may be such that a length of the side closer to the substrate 2 is smaller than a length of the side farther from the substrate 2.

The width A2 (length in the Y-axis direction) of the first optical confinement portion 4f decreases monotonically as the first optical confinement portion 4f extends from the strip waveguide portion 4b toward the slot waveguide portion 4c. The width A2 may decrease uniformly (at a constant rate) as the first optical confinement portion 4f extends from the strip waveguide portion 4b toward the slot waveguide portion 4c. This constant rate is determined, for example, by the amount of change in the width A2 relative to the length LX of the strip waveguide portion 4b in the X-axis direction. A width A6 of the first optical confinement portion 4f at a location farthest from the strip waveguide portion 4b (that is, at a boundary portion between the mode conversion portion 4d and the slot waveguide portion 4c) is, for example, greater than 0 μm and equal to or less than 0.2 μm. The lower limit of the width A6 is a minimum value to which manufacturing can be performed by a semiconductor process used in the manufacture of the optical waveguide element 1, and may be, for example, 0.05 μm. A width (length in the Y-axis direction) of the first optical confinement portion 4f in the strip waveguide portion 4b is, for example, 0.4 μm or more and 1.25 μm or less (as one example, 0.7 μm).

The distance A1 between the pair of the second optical confinement portions 4h decreases monotonically as the second optical confinement portions 4h extend from the strip waveguide portion 4b toward the slot waveguide portion 4c. The distance A1 may decrease uniformly (at a constant rate) as the second optical confinement portions 4h extend from the strip waveguide portion 4b toward the slot waveguide portion 4c. This constant rate is determined, for example, by the amount of change in the distance A1 relative to the length LX of the strip waveguide portion 4b in the X-axis direction. The distance A1 between the pair of the second optical confinement portions 4h in the slot waveguide portion 4c is, for example, 0.15 μm or more and 0.4 μm or less (as one example, 0.28 μm). The distance A1 between two second optical confinement portions 4h at a location farthest from the slot waveguide portion 4c (at the boundary portion between the strip waveguide portion 4b and the mode conversion portion 4d) is, for example, 0.5 μm or more and 1.35 μm or less (as one example, 0.8 μm).

As described above, the first center line of the first optical confinement portion 4f may be coincident with the reference line L. However, the first center line of the first optical confinement portion 4f may be offset from the reference line L by a certain length. For example, in a plan view of the substrate 2, the first center line of the first optical confinement portion 4f may be offset from the reference line L by a length such that the first optical confinement portion 4f does not overlap both the pair of second optical confinement portions 4h. The length that prevents the first optical confinement portion 4f from overlapping both the pair of second optical confinement portions 4h is, for example, 30 nm.

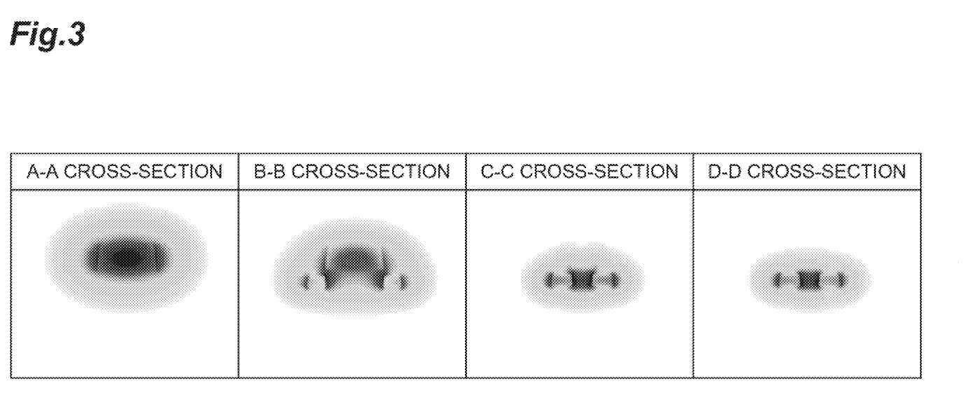

FIG. 3 is a schematic view showing the beam shapes of light propagating through the optical waveguide element 1 along the X-axis direction in a cross-section taken along line A-A of FIG. 1, a cross-section taken along line B-B of FIG. 1, a cross-section taken along line C-C of FIG. 1, and a cross-section taken along line D-D of FIG. 1. Light in the TE0 mode input from the SiN waveguide 5 gradually transitions to the pair of Si waveguides 6 as the light passes through the A-A cross-section, the B-B cross-section, the C-C cross-section, and the D-D cross-section along the X-axis direction. As shown in FIGS. 1, 2, and 3, when the light travels from the A-A cross-section toward the B-B cross-section, a portion of the light that has propagated through the SiN waveguide 5 transitions to the Si waveguides 6 close to the SiN waveguide 5 and located below the SiN waveguide 5.

When the light travels from the B-B cross-section toward the C-C cross-section, the change in light is adiabatic. That is, in the mode conversion portion 4d, there is almost no dissipation of optical power to the outside, and the light smoothly transitions from the SiN waveguide 5 to each of the pair of Si waveguides 6 located below the SiN waveguide 5. Almost no change in light is seen when the light travels from the C-C cross-section toward the D-D cross-section. All the light that has propagated through the SiN waveguide 5 propagates through the pair of Si waveguides 6 at the C-C cross-section. As described above, the transmission of light from the strip waveguide portion 4b to the slot waveguide portion 4c via the mode conversion portion 4d can reduce the loss of light in the optical waveguide element 1 since the waveguide transfer is adiabatic. For example, the larger the length LX of the tapered region (mode conversion portion 4d) in the X-axis direction is and the smaller the degree of reduction (constant rate) in the length of the optical waveguide portion 4 in the Y-axis direction along the X-axis direction is, the more the loss of optical power can be reduced. However, the smaller the length of the tapered region in the X-axis direction is, the more compact the size of the optical waveguide element 1 can be made.

As described above, in the optical waveguide element 1, the strip waveguide portion 4b and the slot waveguide portion 4c are formed in different layers on the substrate 2, and the mode conversion portion 4d is located between the strip waveguide portion 4b and the slot waveguide portion 4c. The mode conversion portion 4d includes the first optical confinement portion 4f formed in the same first layer 3b as the strip waveguide portion 4b, and the second optical confinement portions 4h formed in the same second layer 3c as the slot waveguide portion 4c. The first optical confinement portion 4f is connected to the strip waveguide portion 4b, and the second optical confinement portions 4h are connected to the slot waveguide portion 4c. The width A2 of the first optical confinement portion 4f decreases monotonically as the first optical confinement portion 4f approaches the slot waveguide portion 4c from the strip waveguide portion 4b, and the first optical confinement portion 4f is included inside the second optical confinement portions 4h in a plan view of the substrate 2. In a plan view of the substrate 2, the first optical confinement portion 4f and the second optical confinement portions 4h do not overlap each other. As a result, the width A2 of the first optical confinement portion 4f decreases monotonically as the first optical confinement portion 4f approaches the slot waveguide portion 4c, and the distance A1 between the second optical confinement portions 4h that sandwich the first optical confinement portion 4f therebetween in a plan view of the substrate 2 decreases monotonically as the second optical confinement portions 4h approach the slot waveguide portion. Therefore, the transmission of light in the mode conversion portion 4d located between the strip waveguide portion 4b and the slot waveguide portion 4c can be smoothly performed.

As described above, the strip waveguide portion 4b, the mode conversion portion 4d, and the slot waveguide portion 4c may be arranged in order along the X-axis direction, and the second optical confinement portion 4h, the first optical confinement portion 4f, and the second optical confinement portion 4h may be arranged in order along the Y-axis direction intersecting the X-axis direction. The pair of second optical confinement portions 4h may be disposed at positions where the pair of second optical confinement portions 4h are line-symmetric with each other with respect to the reference line L passing through the center of the first optical confinement portion 4f in the Y-axis direction and extending along the X-axis direction. In addition, the shapes of the pair of second optical confinement portions 4h may be formed to be line-symmetric with each other with respect to the reference line L. In this case, the pair of second optical confinement portions 4h are disposed at positions where the pair of second optical confinement portions 4h are line-symmetric with each other with respect to the reference line L, and the shapes thereof are formed to be line-symmetric with each other, and therefore, the rotation of the polarization of light transmitted from the first optical confinement portion 4f to the pair of second optical confinement portions 4h can be suppressed.

As described above, the difference between the distance A1 between the pair of second optical confinement portions 4h arranged along the Y-axis direction and the width A2 of the first optical confinement portion 4f may decrease monotonically as the pair of second optical confinement portions 4h and the first optical confinement portion 4f approach the slot waveguide portion 4c from the strip waveguide portion 4b. In this case, since the optical coupling between the first optical confinement portion 4f and the second optical confinement portions 4h gradually becomes stronger as the first optical confinement portion 4f and the second optical confinement portions 4h approach the slot waveguide portion 4c from the strip waveguide portion 4b, reflection at the boundary portion between the first optical confinement portion 4f and the strip waveguide portion 4b can be reduced, and the transition of light from the first optical confinement portion 4f to the second optical confinement portions 4h in the mode conversion portion 4d can be more smoothly performed.

As described above, the width A3 of each of the second optical confinement portions 4h may decrease monotonically as the second optical confinement portion 4h extends from the slot waveguide portion 4c toward the strip waveguide portion 4b. In this case, since the width A3 of the second optical confinement portion 4h in the strip waveguide portion 4b is smaller than the width A3 of the second optical confinement portion 4h in the slot waveguide portion 4c, the reflection of light from the strip waveguide portion 4b toward the slot waveguide portion 4c can be reduced.

As described above, in a cross-section orthogonal to the X-axis direction that is a direction in which the strip waveguide portion 4b, the mode conversion portion 4d, and the slot waveguide portion 4c are arranged, the first optical confinement portion 4f may be disposed at a position (layer) above and spaced apart from the second optical confinement portion 4h. The slot waveguide portion 4c may be configured to have the same mode as the mode of the strip waveguide portion 4b. The optical waveguide element 1 may include the cladding 3 formed on the substrate 2, and the strip waveguide portion 4b and the slot waveguide portion 4c may be embedded in the cladding 3. The slot waveguide portion 4c may be formed in the second layer 3c different from the first layer 3b in which the strip waveguide portion 4b is formed.

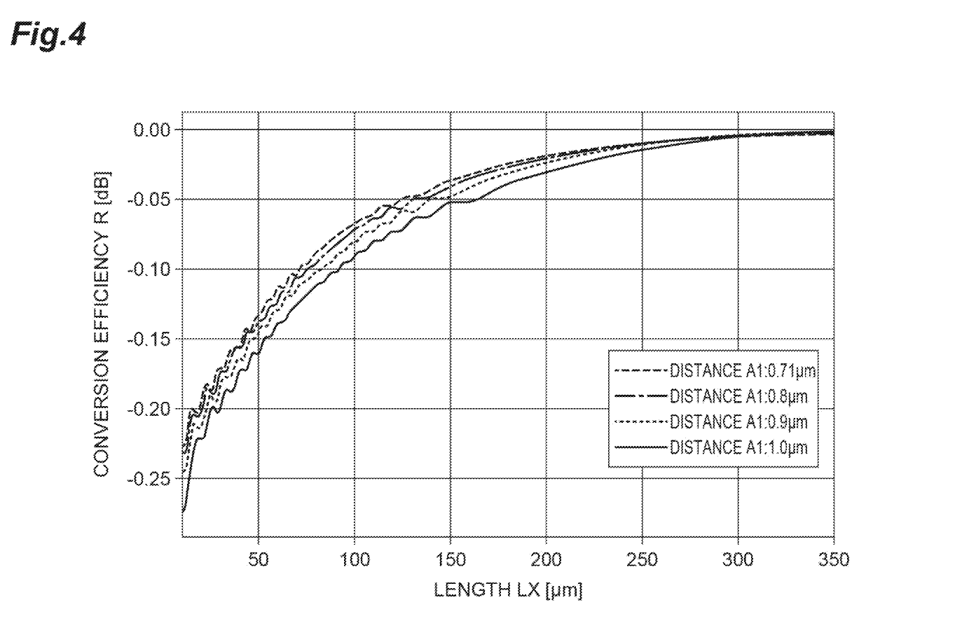

FIG. 4 is a graph showing an example of the relationship between the length LX (horizontal axis) of the mode conversion portion 4d and a conversion efficiency R (vertical axis) of light from the optical waveguide element 1 when the distance A1 between the pair of second optical confinement portions 4h at the boundary portion between the strip waveguide portion 4b and the mode conversion portion 4d is changed. The conversion efficiency R is expressed by Equation R = Pout/Pin, where Pin is the power of light in the TE mode input to the mode conversion portion 4d from the strip waveguide portion 4b, and Pout is the power of light in the TE mode output from the mode conversion portion 4d to the slot waveguide portion 4c. In FIG. 4, the conversion efficiency R is expressed in decibels (dB), and the closer the conversion efficiency R is to 0 dB, the higher the conversion efficiency R becomes, and the further the conversion efficiency R moves away from 0 dB toward the negative side (the smaller the conversion efficiency R is), the lower the conversion efficiency R becomes. It is considered that the decrease in the conversion efficiency R is due to an increase in loss in the mode conversion portion 4d. That is, the higher the conversion efficiency R is, the smaller the loss in mode conversion becomes, and the lower the conversion efficiency R is, the larger the loss in mode conversion becomes. As shown in FIG. 4, the larger the length LX becomes, the higher the conversion efficiency R becomes. In addition, the smaller the distance A1 at the boundary portion between the strip waveguide portion 4b and the mode conversion portion 4d is, the higher the conversion efficiency R that can be obtained becomes. However, in a case where the distance A1 is 0.71 μm or more, for example, the difference in the conversion efficiency R due to the variation in the distance A1 is 0.03 dB or less when the length LX is 50 to 100 μm, and is suppressed to an even smaller value when the length LX is greater than the above-described range. The conversion efficiency R is, for example, -0.15 dB (input/output power ratio 0.97) or more. The conversion efficiency R may be -0.1 dB (input/output power ratio 0.98) or more, and may be -0.05 dB (input/output power ratio 0.99) or more.

The embodiment of the optical waveguide element according to the present disclosure has been described above. However, the present disclosure is not limited to the embodiment described above, and may be modified within the scope of the concept described in the claims. That is, the configuration, shape, size, material, number, and disposition mode of each portion of the optical waveguide element can be modified as appropriate within the scope of the concept.

WHAT IS CLAIMED IS:

1. An optical waveguide element, comprising:
a substrate;
a strip waveguide portion formed in a first layer located above the substrate;
a slot waveguide portion formed in a second layer located above the substrate and different from the first layer; and
a mode conversion portion connected between the strip waveguide portion and the slot waveguide portion,
wherein the mode conversion portion includes a first optical confinement portion formed in the first layer and connected to the strip waveguide portion, and a pair of second optical confinement portions formed in the second layer and connected to the slot waveguide portion,
a width of the first optical confinement portion decreases as the first optical confinement portion approaches the slot waveguide portion from the strip waveguide portion, and
the first optical confinement portion is included inside the pair of second optical confinement portions in a plan view of the substrate.

2. The optical waveguide element according to claim 1,
wherein the strip waveguide portion, the mode conversion portion, and the slot waveguide portion are arranged in order along a first direction, one of the pair of second optical confinement portions, the first optical confinement portion, and the other of the pair of second optical confinement portions are arranged in order along a second direction intersecting the first direction, and the pair of second optical confinement portions are formed to be line-symmetric with each other with respect to a reference line passing through a center of the first optical confinement portion in the second direction and extending along the first direction.

3. The optical waveguide element according to claim 2,
wherein a difference between a distance between the pair of second optical confinement portions arranged along the second direction and the width of the first optical confinement portion decreases monotonically as the pair of second optical confinement portions and the first optical confinement portion approach the slot waveguide portion from the strip waveguide portion.

4. The optical waveguide element according to claim 1,
wherein a width of each of the second optical confinement portions decreases monotonically as the second optical confinement portion extends from the slot waveguide portion toward the strip waveguide portion.

5. The optical waveguide element according to claim 1,
wherein, in a cross-section orthogonal to a first direction in which the strip waveguide portion, the mode conversion portion, and the slot waveguide portion are arranged, the first layer is formed above and spaced apart from the second layer.

6. The optical waveguide element according to claim 1,
wherein the slot waveguide portion has the same optical propagation mode as an optical propagation mode of the strip waveguide portion.

7. The optical waveguide element according to claim 1, further comprising: a cladding formed on the substrate, wherein the first layer and the second layer are provided in the cladding.
